(19) United States
(12) Patent Application Publication
(10) Pub. No.: US 2013/0105383 A1
(43) Pub. Date: May 2, 2013

(54) NANOFILTRATION-TYPE THIN FILM COMPOSITE FORWARD OSMOSIS MEMBRANE AND A METHOD OF SYNTHESIZING THE SAME

(71) Applicant: NANYANG TECHNOLOGICAL UNIVERSITY, Singapore (SG)

(72) Inventors: Chuyang TANG, Singapore (SG); Changquan QIU, Singapore (SG); Jing WEI, Singapore (SG)

(73) Assignee: NANYANG TECHNOLOGICAL UNIVERSITY, Singapore (SG)

(21) Appl. No.: 13/665,243

(22) Filed: Oct. 31, 2012

Related U.S. Application Data
(60) Provisional application No. 61/552,157, filed on Oct. 27, 2011.

(51) Int. Cl. B01D 29/00; B01D 67/00

(52) U.S. Cl. 210/490; 427/244

(57) ABSTRACT

There is provided a nanofiltration-type thin film composite forward osmosis membrane comprising a rejection layer including intrinsic separation properties; and a substrate for support of the rejection layer, the substrate comprising a porous sub-layer having long finger-like pores and a thin sponge-like skin layer. A method for synthesizing the nanofiltration-type thin film composite forward osmosis membrane is also provided.

### TECHNICAL FIELD

This invention relates to a nanofiltration-type thin film composite forward osmosis membrane and a method of synthesizing the same.

### BACKGROUND

Forward osmosis (FO) is an osmotically driven membrane separation technology in which the water flux is driven by an osmotic pressure difference across a semi-permeable membrane. FO does not require an externally applied mechanical pressure. Where a high-osmotic-pressure draw solution (e.g., seawater or process brine) is available or can be easily regenerated (e.g., by using low grade heat), FO energy consumption can be potentially significantly lower than that of pressure-driven processes such as reverse osmosis (RO) and nanofiltration (NF). In addition, FO is a lower fouling alternative to the pressure-driven membrane processes. FO technology has become increasingly attractive for applications in seawater desalination, water and wastewater treatment, and biomass concentration. In addition, FO is ideal for pressure- or heat-sensitive applications (e.g., food processing, pharmaceutical applications, etc.).

At present, synthesis of high-performance FO membrane is still in its early stage of development. There have only been a handful of FO membranes revealed in patents and publications. The Hydration Technologies, Inc. (Albany, Oreg.) developed cellulose-based asymmetric FO membranes (U.S. Pat. No. 7,445,712, WO/2006/110497), which are also the only FO membranes available commercially so far. However, the rejection layer of this type of membrane tends to have low water permeability and limited solute retention. Moreover, this membrane material is susceptible to chemical and biological degradation. In PCT document WO/2009/035415, composite polymeric membranes incorporating nanotubes in either the rejection layer or substrate were developed. In PCT document WO/2008/137082, thin film composite (TFC) FO membranes comprising an RO-type polyamide rejection layer coating on a highly porous substrate (such as a nanofiber web) were disclosed. In PCT document WO/2009/025900, a composite FO membrane consisting of cellulose or cellulose dericative coating layer and a porous support comprising nanofibers was disclosed. In PCT document patent WO/2010/045430, dual-layer FO hollow fibers were invented. A literature investigation shows that thus far, FO membrane fabrication still focuses on RO-type membranes, which aim to have high rejection to all types of solutes and ions. The RO-type FO membranes developed include: 1) TFC FO membrane consisting of an ultrathin polyamide-based RO-like skin layer on a thin and highly porous polyether sulfone or polysulfone substrate [1-4] and 2) asymmetric cellulose acetate flat-sheet FO membrane [5]. One major disadvantage of the RO-type FO membrane is their relatively low water permeability. Conversely, NF-type membranes typically have higher water permeability than RO-type membranes. Additionally, in some applications such as a forward osmosis membrane bioreactor (OMBR), salt accumulation has an adverse effect on the biomass. Water flux reduction and deterioration of biological activity in the OMBR system may take place, partly due to the build-up of salinity in the OMBR.

Typical NF membranes, however, perform poorly under FO conditions because their thick and compact support layer greatly hinder the mass diffusions between the bulk solution and interface of active rejection layer and support layer, thus dramatically cut down the effective osmotic pressure difference, which is known as internal concentration polarization (ICP), leading to low FO water flux. There have been optimized NF-type FO membrane published, including asymmetric polybenzimidazole (PBI) hollow fibers [6], dual-layer polybenzimidazole-polyethersulfonr/polyvinylpyrrolidone (PBI-PES/PVP) hollow fibers [7], asymmetric cellulose acetate (CA) hollow fibers [8, 9], and double-skinned cellulose acetate flat-sheet membrane [10]. These membranes, however, exhibited low FO water flux due to both the low permeability of rejection layer and high ICP propensity of the dense sponge-like support layer.

### SUMMARY

Nanofiltration-type thin film composite forward osmosis (NF-type TFC FO) membranes have been developed in which a rejection layer of the membranes is designed to have high water permeability and high retention to divalent (and multivalent) salts. Meanwhile, substrates of the membranes were optimized to be thin and highly porous, with long finger-like pore structure under a thin sponge-like skin layer. These finger-like pores are favored to FO membranes because they generate less resistance to salt and water diffusion and thus reduce the ICP propensity of membranes.

Such NF-type TFC FO membranes are developed or synthesized via a two-step process, a phase inversion step to fabricate a highly porous and low-ICP-propensity substrate with long finger-like pore structure, then an interfacial polymerization step to synthesize a high-water-permeability NF-like rejection layer on top of the substrate.

According to a first aspect, there is provided a nanofiltration-type thin film composite forward osmosis membrane comprising a rejection layer including intrinsic separation properties; and a substrate for support of the rejection layer, the substrate comprising a porous sub-layer having long finger-like pores and a thin sponge-like skin layer.

It is preferable that the substrate is configured to have low internal concentration polarization propensity and the rejection layer is configured to have high water permeability and high rejection to divalent ions but low rejection to monovalent ions. The substrate may be about 40 to 200 μm thick. The thin sponge-like skin layer may be less than 5 μm thick. The rejection layer may be an ultrathin polyamide layer.

Preferably, the substrate has a pure water flux ranging from 30 to 1000 L/m².h.bar, a porosity ranging from 30 to 90% and a contact angle ranging from 40° to 100°.

The membrane may have a water flux higher than 5 L/m².h.bar and a salt rejection higher than 85% for Na₂SO₄ when tested using a 100 ppm Na₂SO₄ feed solution at a trans-membrane pressure of 100 kPa at 23° C.

According to a second aspect, there is provided a method of synthesizing a nanofiltration-type thin film composite forward osmosis membrane, the membrane comprising a substrate comprising a layer having long finger-like pores and a thin sponge-like skin layer, and a rejection layer formed on the substrate. The method comprises the steps of forming the substrate by phase inversion of a polymer solution; and forming the rejection layer by interfacial polymerization.

It is preferable that forming the substrate by phase inversion of a polymer solution comprises dissolving a polymer and additives in an organic solvent to form a polymer solution; filtering the polymer solution; degassing the filtered polymer solution; spreading the degassed, filtered polymer solution onto a glass plate; and immersing the glass plate spread with the degassed, filtered polymer solution into a coagulant bath.

The polymer may be selected from, for example, polysulfone, polyether sulfone, polyacrylonitrile, polyetherimide, polyvinylidene fluoride and so forth. The organic solvent may be selected from, for example, 1-methyl-2-pyrrolidone, dimethyl acetamide, dimethyl formamide and the like. Preferably, the additives are pore formers and may be at least one selected from, for example, macromolecule organics, small molecule organics, small molecule inorganic salts, polyethylene glycol, polyvinyl pyrrolidone, isopropanol, ethanol, lithium chloride and the like.

It is preferable that forming the rejection layer by interfacial polymerization comprises heat pretreatment, soaking the substrate in an amine solution, removing excessive amine solution from the substrate, and introducing an acyl chloride solution onto the substrate soaked in the amine solution. The amine solution may comprise a piperazine and additives dissolved in ultrapure water. The acyl chloride solution may comprise a reactive monomer and additives dissolved in an organic solvent.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is Scanning Electron Microscope (SEM) micrographs of an NF-type TFC FO membrane at (a) cross-section, (b) close-up cross-section, (c) top surface and (d) bottom surface;

FIG. 2 is a schematic illustration of a cross-flow RO setup for measuring intrinsic separation performance of a membrane;

FIG. 3 is a schematic illustration of a cross-flow FO setup for membrane testing;

FIG. 4 is a flow chart of an exemplary method of the invention;

FIG. 5(a) shows FO water flux of NF-type TFC FO membranes in membrane orientation of active-layer-facing-draw-solution (AL-DS);

FIG. 5(b) shows FO water flux of NF-type TFC FO membranes in membrane orientation of active-layer-facing-feed-solution (AL-FS); and

FIG. 6 shows FO salt flux/water flux ratio of NF-type TFC FO membranes using different draw solutes.

### DETAILED DESCRIPTION OF EXEMPLARY EMBODIMENTS

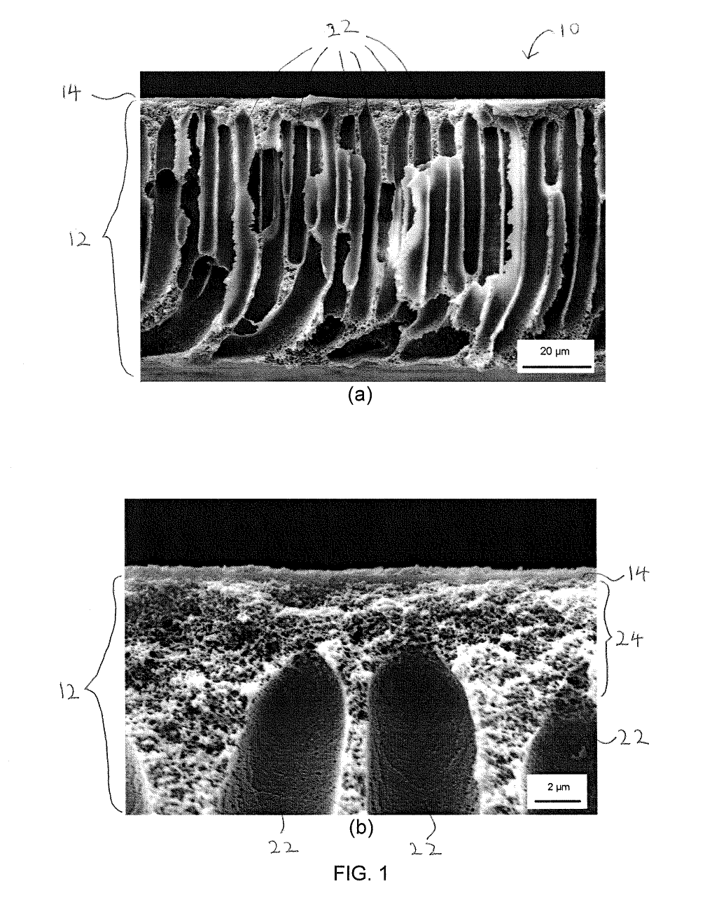

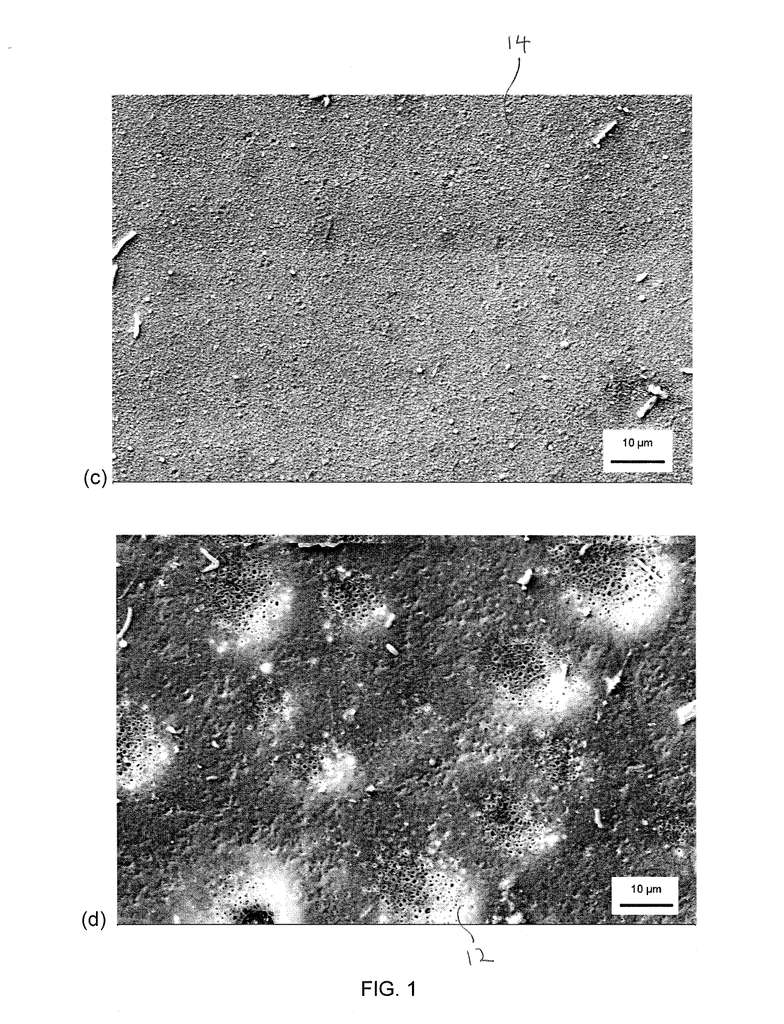

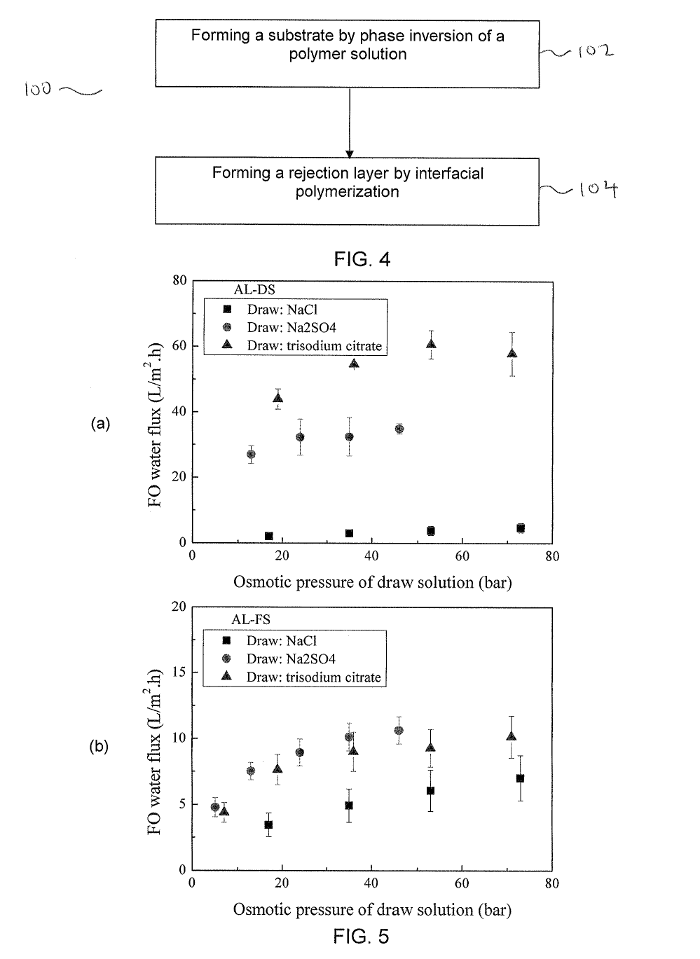

Exemplary embodiments of a nanofiltration-type thin film composite forward osmosis membrane 10 and a method 100 of synthesizing the same 10 will be described with reference to FIGS. 1 to 6 below.

Embodiments of the NF-type TFC FO membrane 10 were synthesized via a two-step process or method 100: 1) a phase inversion step 102 to form the membrane substrate 12, and 2) an interfacial polymerization step 104 to form the active rejection layer 14 on top of the substrate 12.

In the phase inversion step 10, a casting solution was prepared in which certain amounts of a polymer and additives functioning as pore formers were dissolved in an organic solvent to form a polymer solution and stirred by magnetic stirrers at 70° C. until the polymer solution became homogeneous and transparent. After cooling down to room temperature (23° C.), the polymer solution was filtered with a stainless steel filter connected to a compressed nitrogen gas cylinder to obtain a filtered dope. The filtered dope was then degassed in air-tight bottles for 24 hours before use, to obtain the casting solution.

The casting solution was spread onto a clean glass plate to form a uniform film using an Elcometer 4340 Motorised Film Applicator (Elcometer Asia Pte Ltd). The film was then quickly and smoothly immersed with the glass plate into a coagulant bath where tap water was used as coagulant. The nascent substrate was kept in a flowing water bath to remove residual solvent, and stored in ultrapure water before use.

The polymer used above to form the casting solution may be polysulfone (PSF), polyether sulfone (PES), polyacrylonitrile (PAN), Polyetherimide (PEI), Polyvinylidene Fluoride (PVDF), etc, of which the concentration in polymer solution was from 12.0 to 25.0 wt. % (preferably 15.0˜20.0 wt. %). The organic solvent in which the polymer was dissolved was selected from 1-Methyl-2-Pyrrolidone (NMP), dimethyl acetamide (DMAc), Dimethyl Formamide (DMF) and a combination of thereof. The additives acting as pore formers included macromolecule organics, small molecule organics and inorganic salts, such as polyethylene glycol (PEG), polyvinyl pyrrolidone (PVP), isopropanol, ethanol, lithium chloride (LiCl), etc. Total concentration of the additives in the polymer solution was from 0.1 to 10.0 wt. % (preferably 3.0˜8.0 wt. %). Room temperature tap water with a certain ratio of solvents was used as the coagulant bath. The added solvents were selected from NMP, DMAc, DMF, ethanol, etc, of which the concentration was from 0 to 30.0 wt. % (preferably 0˜10.0 wt. %). The solvents were added to the coagulant bath before immersion of the film. This aids in formation of a solid substrate with tailored pore structure.

The resulting substrates 12 formed had a thickness ranging from 40 to 200 μm (preferably 50˜80 μm), pure water flux from 30 to 1000 L/m².h.bar (preferably 100˜500 L/m².h.bar) under 100 kpa (1 bar), porosity from 30 to 90% (preferably 60˜85%), contact angle from 40 to 100° (preferably 50˜80°). The cross-section of the substrates 12 had highly porous structures with long finger-like pores 22 formed under a thin sponge-like skin layer 24, as shown in the SEM images of FIG. 1. The SEM images were taken using a Zeiss Evo 50 Scanning Electron Microscope (Carl Zeiss AG). Thickness of the skin layer was less than 5 μm.

In the interfacial polymerization step 102, to prepare the active rejection layer 14, a pre-casted substrate 12 was heated in ultrapure water at a temperature of 60˜90° C. (preferably 70˜80° C.) for 1˜5 minutes (preferably 1˜2 minutes) before cooling down to room temperature. It 12 was then soaked in an aqueous solution of amine for 2˜10 minutes (preferably 2˜5 minutes), and excessive amine solution on the substrate 12 surface was removed with either compressed air or a stream of nitrogen. Subsequently, acyl chloride dissolved in an organic solvent was gently poured onto the amine-soaked substrate and was allowed to react with the residual amine for 0.5˜10 minutes (preferably 1˜2 minutes) to form the ultrathin polyamide rejection layer 14. The resultant TFC membrane was rinsed with ultrapure water to remove residual monomers and was stored in ultrapure water before use.

The amine solution in which the substrate 12 was soaked was prepared by dissolving a piperazine (PIP) and additives in ultrapure water. The additives include, for example, surfactants, bases, and the like. The total concentrations of PIP and additives in the ultrapure water ranged from 0.5 to 4.0 wt. % (preferably 1.0˜2.5 wt. %).

The acyl chloride solution was prepared by dissolving a reactive monomer selected from trimesoyl chloride (TMC), 5-isocyanato-isophthaloyl chloride (ICIC), 5-chloroformyloxy-isophthaloyl chloride (CFIC), etc., together with additives in an organic solvent (e.g. n-hexane, cyclohexane, acetone, etc.). The total concentrations of monomer and additives in the organic solvent were from 0.05 to 2.0 wt./v % (preferably 0.1˜0.5 wt./v. %)

The resulting NF-type TFC FO membranes 10 had water flux higher than 5 L/m².h.bar, high salt rejection to divalent and multivalent solutes, (for example, higher than 85% for Na₂SO₄ (testing condition: 100 ppm Na₂SO₄ solution as feed, trans-membrane pressure (TMP) of 100 kPa, 23° C.)), but low rejection to monovalent solutes. In FO testing, the membrane exhibited water flux higher than 50 L/m².h with 0.5 M Na₂SO₄ as draw solution in the active-layer-facing-draw-solution orientation at 23° C.

### EXAMPLE 1

A casting solution containing 16 wt. % PSF, 5.0 wt. % PEG (molecular weight of 600) and 2.0 wt. % LiCl in NMP was prepared. To prepare the membrane substrate 12, the casting solution was spread onto a clean glass plate. The gap between the casting knife used and the glass plate, i.e. the thickness of casting solution, was 175 μm. The film of casting solution was then quickly and smoothly immersed with the glass plate into a coagulant bath to initiate phase separation. Room temperature tap water was used as the coagulant.

Two monomer solutions were prepared for interfacial polymerization 104 which forms an NF-type rejection layer on the prepared substrate 12. An aqueous amine solution was prepared by dissolving 1.0 wt. % PIP in water. 1.0 wt. % triethylamine (TEA) and 0.1 wt. % sodium dodecyl sulfate (SDS) were used as additives in the aqueous phase. An acyl chloride solution was prepared by dissolving 0.2 wt./v. % TMC in n-hexane. A pre-cast polysulfone substrate was first subject to heat pretreatment, and was brought into contact with the PIP solution and TMC solution successively for interfacial polymerization. Reaction time of the interfacial polymerization 104 was 1 minute.

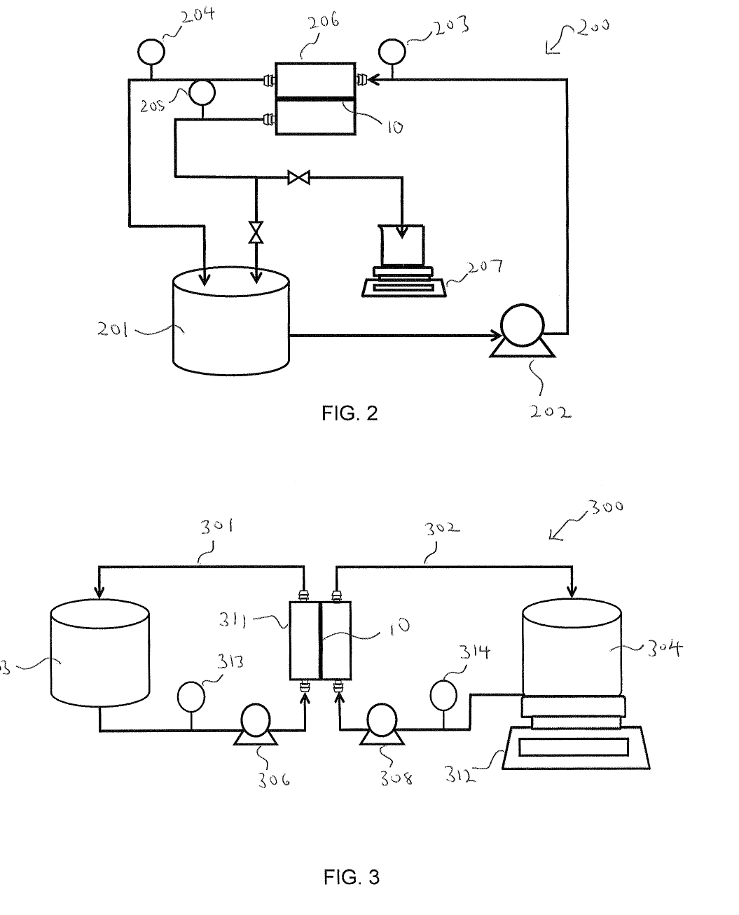

To test the intrinsic separation properties of the prepared composite membranes 10, a cross-flow RO setup 200 as shown in FIG. 2 was used. The membrane being evaluated was mounted in a membrane cell 206 of plate-frame configuration. A feed solution (100 ppm aqueous salt solution) was pumped via a pump 202 from a feed tank 201, flowed against the active rejection layer 14 of the membrane 10 in the membrane cell 206 and returned to the tank 201. Pressure transducers 203, 204, 205 were provided for the feed, the retentate and the permeate respectively.

The permeate was collected and measured for its weight and concentration to determine water flux and salt rejection. The substrate 12 was firstly compacted with TMP of 100 kPa (1 bar) until a steady permeate rate was reached. Samples for measurement were then taken at TMP of 100 kPa (1 bar). Temperature was kept constant at 23° C.

For testing FO performance of the TFC membrane 10, a cross-flow FO set-up 300 as shown in FIG. 3 was used. The setup 300 consisted of two loops 301, 302, with draw solution and feed solution flowing on opposite sides of the membrane 10, as supplied by a draw solution tank 303 and a feed solution tank 304 driven by pumps 306, 308 respectively. The membrane 10 was fixed in a testing cell 311 with a plate-frame configuration. The effective membrane area was 60 cm². Identical spacers (not shown) were placed on both sides of membrane 10 to reduce external concentration polarization. The flow rates of feed and draw streams were both 500 ml/min. Temperature was kept constant at 23° C. Conductivity meters 313, 314 were provided for each loop 301, 302 respectively to monitor the concentrations of feed and draw solutions, and to determine the reverse diffusion of solute through the membrane.

Pure water and 10 mM NaCl aqueous solution was used as feed solutions. Aqueous solutions, such as, for example, 0.5M Na₂SO₄, 0.75 M MgSO₄, 0.5M MgCl₂ and 0.75 M NaCl, were used as draw solutions in separate tests. Both feed and draw solutions were of a volume of 3.8 L at the beginning of each test. Two membrane orientations, active-layer-facing-draw-solution (AL-DS) and active-layer-facing-feed-solution (AL-FS), were applied in each group of membrane testing. Water flux and salt flux was determined by measuring the volume and concentration changes of the feed solution respectively.

Table 1 below shows the characteristics of the membrane substrates 12 prepared.

TABLE 1
Characteristics of substrate prepared for NF-Type TFC FO membrane

| | Thickness | Porosity | Contact angle | Pure water flux |
|---|---|---|---|---|
| Sample | (μm) | (%) | (°) | (L/m² · h · bar) |
| Membrane | 80 | 81 | 65 | 466 |
| substrate | | | | |

Table 2 below shows the intrinsic separation properties of the NF-type TFC FO membrane 10 synthesized.

TABLE 2
Intrinsic separation properties of NF-type TFC FO membrane

| | Feed salt | | | |
|---|---|---|---|---|
| | Na₂SO₄ | MgSO₄ | MgCl₂ | NaCl |
| Water flux (L/m² · h · bar) | 5.41 | 5.20 | 5.61 | 5.74 |
| Salt rejection (%) | 88.59 | 83.40 | 34.19 | 8.08 |

Testing conditions: 100 ppm salt-containing aqueous solution as feed, 100 kPa (1 bar) TMP at 23° C.

Table 3 and Table 4 below show the FO performance of the NF-type TFC FO membrane 10 synthesized.

TABLE 3
FO performance of NF-type TFC FO membrane

| | | Draw solution | | | |
|---|---|---|---|---|---|
| | | 0.5M | 0.75M | 0.5M | 0.75M |
| | | Na₂SO₄ | MgSO₄ | MgCl₂ | NaCl |
| AL-DS | Water flux | 59.3 | 39.2 | 32.7 | 21.6 |
| | (L/m² · h) | | | | |
| | Salt flux | 17.5 | 4.7 | 38.4 | 106.2 |
| | (g/m² · h) | | | | |
| AL-FS | Water flux | 16.9 | 7.4 | 10.6 | 8.9 |
| | (L/m² · h) | | | | |
| | Salt flux | 2.7 | 3.6 | 62.2 | 158.4 |
| | (g/m² · h) | | | | |

Testing conditions: ultrapure water as feed solution, various salt solutions as draw solutions, 23° C.

TABLE 4
FO performance of NF-type TFC FO membrane

| | | Draw solution | | | |
|---|---|---|---|---|---|
| | | 0.5M | 0.75M | 0.5M | 0.75M |
| | | Na₂SO₄ | MgSO₄ | MgCl₂ | NaCl |
| Water flux | AL-DS | 37.5 | 29.6 | 24.8 | 20.1 |
| (L/m² · h) | AL-FS | 17.4 | 7.7 | 10.4 | 8.2 |

Testing conditions: 10 mM NaCl as feed solution, various salt solutions as draw solutions, 23° C.

### EXAMPLE 2

To prepare the substrate, a polymer solution containing 16.0 wt. % polysulfone, 5.0 wt. % PEG, and 2.0 wt. % LiCl in NMP was prepared and was spread onto a clean glass plate at a casting gate height of 150 μm. The casted film was immediately immersed into a tap water coagulant bath to induce phase separation.

The rejection layer of FO membrane was synthesized via interfacial polymerization. Pre-cast polysulfone substrate was heated in a 70° C. water bath for 2 min, following by quenching in 23° C. water bath. The substrate was then soaked in a PIP aqueous solution for 2 min. The PIP solution consisted of PIP 1.0 wt. %, TEA 1.0 wt. %, SDS 0.1 wt. % in water. Excess PIP solution was removed from membrane surface using compressed nitrogen. Then the substrate was brought into contact with n-hexane solution of TMC for 1 min. The TMC solution was prepared by dissolving 0.2 wt./v. % TMC in n-hexane.

The interfacial polymerization reaction between PIP and TMC monomers formed a crosslinked ultrathin polyamide rejection layer on the substrate.

Intrinsic separation properties of the NF-type TFC FO membranes were evaluated in the cross-flow RO setup at 23° C. with a feed pressure of 5 bar. Water permeability was determined using pure water as feed and was calculated by measuring the permeate flux through membrane. Salt permeability values to three salts (NaCl, Na₂SO₄ and trisodium citrate) were evaluated individually using a feed salt concentration of 10 mM. Conductivities of feed and permeate streams were measured to calculate membrane rejection as well as salt permeability.

FO water flux and salt flux of the NF-type TFC FO membranes were evaluated using the cross-flow FO setup. Draw solutions were prepared using NaCl, Na₂SO₄, or trisodium citrate. Pure water and 10 mM NaCl were used as feed solutions. Both the AL-DS and AL-FS orientations were evaluated. Temperature of all the FO tests were maintained at 23° C. Water flux and salt flux were determined by measuring the volume and concentration changes of the feed solution, respectively.

Table 5 below shows the surface properties and intrinsic separation properties of the NF-type TFC FO membrane synthesized.

TABLE 5
Intrinsic separation properties of NF-type TFC FO membrane

| | |
|---|---|
| Surface roughness (nm) | 29.0 ± 4.4 |
| Contact angle (°) | 25.7 ± 3.9 |
| Water permeability (L/m² · h · bar)^{a} | 5.01 ± 0.25 |
| NaCl rejection^{b} (%) | 33.3 ± 0.2 |
| Na₂SO₄ rejection^{b} (%) | 98.8 ± 0.01 |
| Trisodium citrate rejection^{b} (%) | 99.4 ± 0.01 |

^{a}Determined with pure water feed in RO mode at 5 bar and 23° C. The experimental errors are reported as the standard deviation of at least three repeated measurements.
^{b}Determined with 10 mM salt in feed in RO mode at 5 bar and 23° C. The experimental errors are reported as the standard deviation of at least three repeated measurements.

Referring to FIG. 5(a), there is provided FO water flux of NF-type TFC FO membranes in membrane orientation active-layer-facing-draw-solution (AL-DS). Referring to FIG. 5(b), there is provided FO water flux of NF-type TFC FO membranes in membrane orientation active-layer-facing-feed-solution (AL-FS). The tests were operated using 10 mM NaCl as feed and different salts as draw solute (in accordance with the legend of FIG. 5) at 23° C. Osmotic pressures of draw solutions were calculated by OLI System software. Error bars represent standard deviations of results of at least three repeated measurements.

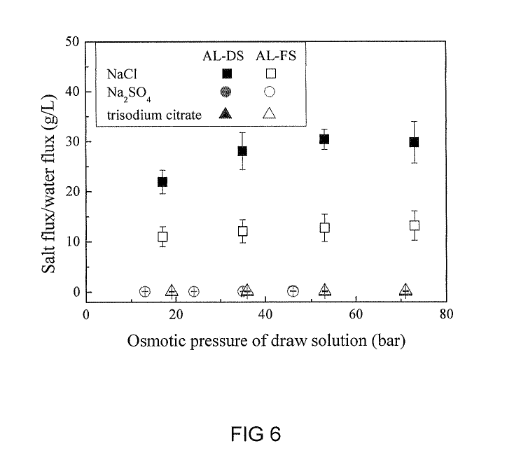

Referring to FIG. 6, there is provided FO salt flux/water flux ratio of NF-type TFC FO membranes using different draw solutes (in accordance with the legend of FIG. 6). Pure water was used as feed and testing temperature was 23° C. Osmotic pressures of draw solutions were calculated by OLI System software. Error bars represent standard deviations of results of at least three repeated measurements.

The NF-type TFC FO membranes 10 in this invention have been optimized to have high performance in FO conditions. In addition, the membranes 10 are made from widely used macromolecule materials with very good biological and chemical stability. Therefore, the membranes 10 can be possibly used in the fields of wastewater treatment, biomass concentration, food processing, pharmaceutical applications, etc. The preferential retention against divalent ions means divalent (or multivalent) draw solutes can be effectively retained by the membranes 10 while monovalent solutes are allowed to pass through the membranes 10. This can potentially solve the solute accumulation problem in FO modules/bioreactors.

Whilst there has been described in the foregoing description exemplary embodiments of the present invention, it will be understood by those skilled in the technology concerned that many variations in details of design, construction and/or operation may be made without departing from the present invention. For example, other aliphatic diamines may be used as the amine monomer for the interfacial polymerization step. Chemical post-treatment, such as acid/base wash or partial chlorination may be used to modify the cross-linking density of the selective layer. Membrane surface modification such as surface coating, plasma treatment, etc. may be performed as surface treatment can improve membrane rejection and surface properties in terms of hydrophilicity, surface charge, surface roughness and chemical resistance, etc. Incorporation of nano-particles and water channels into the selective layer may be carried out to improve membrane flux and rejection properties.

1. A nanofiltration-type thin film composite forward osmosis membrane comprising:
a rejection layer including intrinsic separation properties; and
a substrate for support of the rejection layer, the substrate comprising a porous sub-layer having long finger-like pores and a thin sponge-like skin layer.

2. The membrane of claim 1, wherein the substrate is configured to have low internal concentration polarization propensity and the rejection layer is configured to have high water permeability and high rejection to divalent ions but low rejection to monovalent ions.

3. The membrane of claim 1, wherein the substrate is about 40 to 200 μm thick.

4. The membrane of claim 1, wherein the thin sponge-like skin layer is less than 5 μm thick.

5. The membrane of claim 1, wherein the substrate has a pure water flux ranging from 30 to 1000 L/m².h.bar, a porosity ranging from 30 to 90% and a contact angle ranging from 40° to 100°.

6. The membrane of claim 1, wherein the rejection layer is an ultrathin polyamide layer.

7. The membrane of claim 1, having a water flux higher than 5 L/m².h.bar and a salt rejection higher than 85% for Na₂SO₄ when tested using a 100 ppm Na₂SO₄ feed solution at a trans-membrane pressure of 100 kPa at 23° C.

8. A method of synthesizing a nanofiltration-type thin film composite forward osmosis membrane, the membrane comprising a substrate comprising a layer having long finger-like pores and a thin sponge-like skin layer, and a rejection layer formed on the substrate; the method comprising the steps of:
forming the substrate by phase inversion of a polymer solution; and
forming the rejection layer by interfacial polymerization.

9. The method of claim 8, wherein forming the substrate by phase inversion of a polymer solution comprises dissolving a polymer and additives in an organic solvent to form a polymer solution; filtering the polymer solution; degassing the filtered polymer solution; spreading the degassed, filtered polymer solution onto a glass plate; and immersing the glass plate spread with the degassed, filtered polymer solution into a coagulant bath.

10. The method of claim 8, wherein the polymer is one selected from the group consisting of: polysulfone, polyether sulfone, polyacrylonitrile, polyetherimide, and polyvinylidene fluoride.

11. The method of claim 8, wherein the organic solvent is at least one selected from the group consisting of: 1-methyl-2-pyrrolidone, dimethyl acetamide, and dimethyl formamide.

12. The method of claim 8, wherein the additives are pore formers and are at least one selected from the group consisting of: macromolecule organics, small molecule organics, small molecule inorganic salts, polyethylene glycol, polyvinyl pyrrolidone, isopropanol, ethanol, and lithium chloride.

13. The method of claim 8, wherein forming the rejection layer by interfacial polymerization comprises heat pretreatment, soaking the substrate in an amine solution, removing excessive amine solution from the substrate, and introducing an acyl chloride solution onto the substrate soaked in the amine solution.

14. The method of claim 13, wherein the amine solution comprises a piperazine and additives dissolved in ultrapure water.

15. The method of claim 13, wherein the acyl chloride solution comprises a reactive monomer and additives dissolved in an organic solvent.
